(19) United States
(12) Patent Application Publication
(10) Pub. No.: US 2003/0139142 A1
(43) Pub. Date: Jul. 24, 2003

(54) Radio communication apparatus equipped with temperature control function

(75) Inventor: James Wang, Hsinchu Hsien (TW)

Correspondence Address: BRUCE H. TROXELL, SUITE 1404, 5205 LEESBURG PIKE, FALLS CHURCH, VA, 22041, US

(73) Assignee: GemTek Technology Co., Ltd.

(21) Appl. No.: 10/337,778

(22) Filed: Jan. 8, 2003

(30) Foreign Application Priority Data
Jan. 22, 2002 (TW) 91200573

(51) Int. Cl. H04B 17/00

(52) U.S. Cl. 455/67.1; 455/550; 455/66

(57) ABSTRACT

A radio communication apparatus equipped with temperature control function consists of a circuit board, a metal lid and a heater. The circuit board has a surface mounted with a plurality of electronic elements for processing and converting radio signals. The metal lid is coupled with the circuit board for encasing the electronic elements. The heater has a thermo-control switch to detect the temperature of circuit board surface, and based on the detected temperature to control heater to heat the metal lid for maintaining the temperature of the circuit board surface within a selected temperature range.

### FIELD OF THE INVENTION

The present invention relates to a radio communication apparatus and particularly to a radio communication apparatus that has temperature control function.

### BACKGROUND OF THE INVENTION

The thriving development of radio communication technology has made transmission of digital information by radio wave widely adopted these days. Its applications have spread to areas such as mobile communications, video and audio transmission, the Internet and electronic mail, etc.

Depending on different design requirements of radio communication apparatus, electronic elements being used also are different. For a radio communication apparatus, the basic structural elements generally are shown in FIG. 1, in which a radio communication apparatus 10 consists of an antenna 11, an amplifier 12, an analog-digital (A/D) converter 13 and a digital signal processor 14. The antenna 11 mainly for transmitting or receiving signals in an electromagnetic form. The amplifier 12 is for boosting and filtering waves. The A/D converter 13 performs conversion function between analog signals and digital signals. The digital signal processor 14 performs processing function including coding and decoding of digital signals. While the antenna 11 has a specific structure and construction, all other elements are formed in integrated circuit (IC) formats and are packaged for mounting to circuit boards.

FIG. 2 shows the structure of a conventional radio communication apparatus. It includes a metal casing 20, a circuit board 21, a plurality of electronic elements 22 and an antenna 23. As previously discussed, the electronic elements 22 include at least an amplifier, an A/D converter and a digital signal processor, and are mounted to the surface of a circuit board 21 by means of Surface Mount Technology (SMT) or soldering. Then the electronic elements 22 and the circuit board 21 are integrated inside the metal casing 20. In order for the radio communication apparatus to obtain better communication quality, the antenna 23 generally is disposed outside the metal casing 20 at a desired location for transmitting or receiving signals, then the signals are transferred through a signal transmission line 24 to or from the electronic elements 22 on the circuit board 21.

However conventional radio communication apparatus still have many problems required improvements or to be resolved, especially when they are used in the warm or cold areas. Many electronic elements in the radio communication apparatus are prone to malfunction when temperature drops excessively low. Some countries have blizzards in winter season with the temperature dropping to ten degrees or more below zero. If disasters hit and the radio communication apparatus cannot function properly, it could incur serious consequences. While a higher placed antenna can generate better quality signals, it also tends to incur signal loss due to the signal transmission line is stretched too long.

To address the shortcomings mentioned above, a radio communication apparatus with temperature control function that can maintain the electronic elements in the apparatus within a selected temperature range so that the electronic elements won't malfunction because of too low of temperature is a commendable approach. In addition, to integrate the antenna and the radio communication apparatus together can also facilitate installation of the radio communication apparatus, and can prevent signal loss due to too long of the signal transmission line.

### SUMMARY OF THE INVENTION

The primary object of the invention is to provide a radio communication apparatus that has temperature control function for maintaining electronic elements in the apparatus within a selected temperature range to prevent the electronic elements from malfunction due to too low of temperature.

The radio communication apparatus according to the invention consists of a circuit board, a plurality of electronic elements, a metal lid, a heater, a casing and an antenna. The electronic elements are soldered to the surface of the circuit board. The metal lid is coupled with the circuit board for encasing the electronic elements. The antenna and circuit board are integrated inside the casing for transmitting data signals through a signal transmission line. The heater is located on the metal lid and includes a thermo-control switch for sensing the temperature of the surface of the circuit board. When the thermo-control switch detects the temperature of the circuit board is too low, it controls the heater to heat the metal lid until the temperature of the circuit board surface reaching a selected temperature, then controls the heater to stop heating the metal lid so that the temperature of the electronic elements on the circuit board is maintained within a selected range. Thus the radio communication apparatus can be prevented from malfunction due to too low of temperature.

By means of the construction set forth above, the radio communication apparatus of the invention can maintain the temperature of the electronic elements mounting on the surface of the circuit board within a selected range. Thus the radio communication apparatus can be prevented from malfunction due to too low of temperature. Moreover, the antenna is integrated inside the casing of the radio communication apparatus. In addition to make assembly easier, the problem of signal loss due to too long of the signal transmission line that incurs to conventional techniques can also be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic system architecture diagram of a radio communication apparatus.

FIG. 2 is a schematic structural view of a conventional radio communication apparatus.

FIG. 3 is a schematic view of a radio communication apparatus equipped with temperature control function of the invention.

FIG. 4 is a schematic view of another embodiment of the radio communication apparatus equipped with temperature control function of the invention.

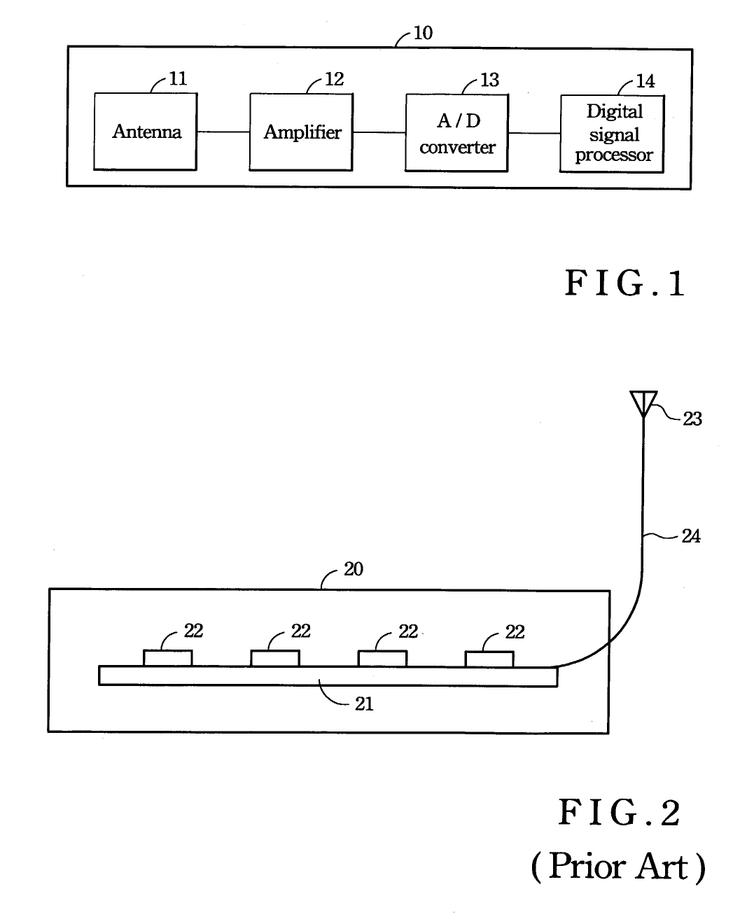

### DESCRIPTION OF THE PREFERRED EMBODIMENTS

The invention aims to provide a radio communication apparatus that has temperature control function for maintaining electronic elements in the apparatus within a selected temperature range to prevent the radio communication apparatus from malfunction due to too low of temperature. Function and features of the invention may be best understood through embodiments depicted below.

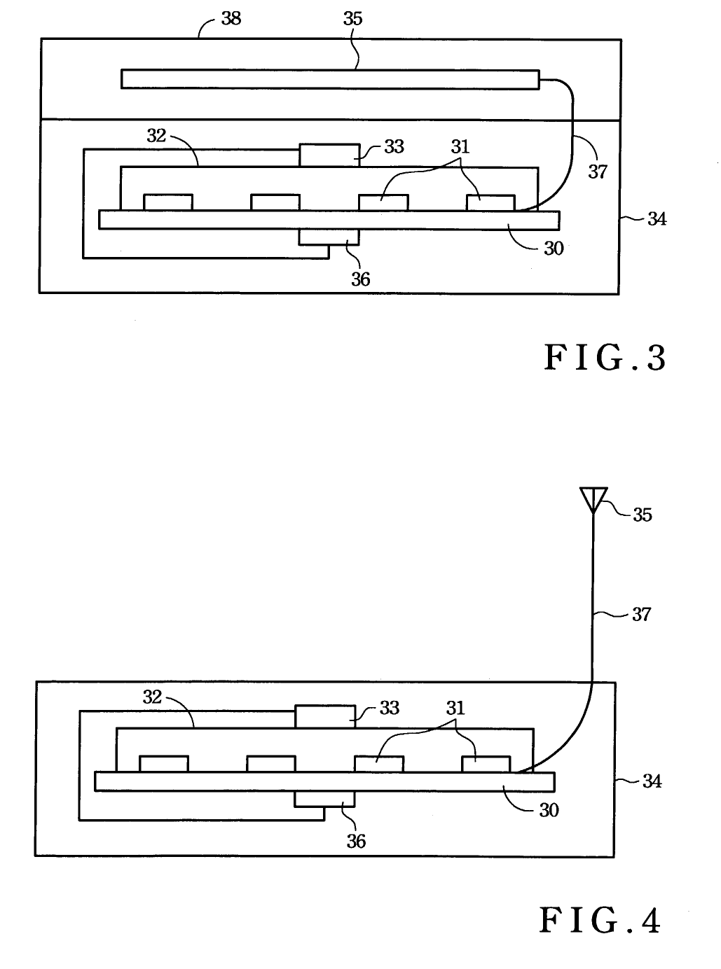

Referring to FIG. 3, the radio communication apparatus equipped with temperature control function according to the invention includes a circuit board 30, a plurality of electronic elements 31, a metal lid 32, a heater 33, a casing 34 and an antenna 35. The electronic elements 31 include at least an amplifier, an A/D converter and a digital signal processor, and are mounted to the surface of the circuit board 30 by means of SMT or soldering. The metal lid 32 is coupled with the circuit board 30 for encasing the electronic elements 31 inside, and is preferably made of aluminum or its alloy. The heater 33 is a ceramic heater and is located on the surface of the metal lid 32, and includes a thermo-control switch 36 which can sense the temperature of the surface of the circuit board 30. The thermo-control switch 36 is a composite metal strip consisting of a bi-metallic strip of different expansion coefficients and is located below the circuit board 30. When the thermo-control switch 36 detects the temperature of the circuit board 30 is too low, and the bi-metallic strip is deformed, the thermo-control switch 36 controls the heater 33 to heat the metal lid 32 to increase the surface temperature of the circuit board 30 until the bi-metallic strip is heated and restored to its original form. Then the thermo-control switch 36 controls the heater 33 to stop heating the metal lid 32. Thereby the temperature of the electronic elements 31 on the circuit board 30 can be controlled within a selected range to avoid the radio communication apparatus from malfunction due to too low of temperature. The temperature range controlled by the thermo-control switch 36 depends on the expansion coefficient of the bi-metallic strip. In one embodiment of the invention, the temperature range for the circuit board 30 is preferably between 5 and 20 degrees Celsius.

The circuit board 30, electronic elements 31, metal lid 32 and heater 33 of the invention are integrated in the casing 34. The antenna 35 may be located inside the casing 34 or outside the casing 34. When the antenna 35 is located inside the casing 34 (as shown in FIG. 3), signal transmission line 37 between the circuit board 30 is shorter and can reduce signal loss. In such a circumstance, the lower lid of the casing 34 is made of metal such as aluminum to facilitate heat radiating. The upper lid covering the surrounding of the antenna 35 must be made of a non-metal material such as a plastic product 38 that can withstand outdoor high or low temperature. The plastic product 38 can prevent the antenna 35 from shielding effect and avoid affecting signal transmission quality. To integrate the antenna 35 inside the casing 34 is a preferred embodiment of the invention, as it has a simpler structure and is easier to install, and costs lower. When the antenna 34 is located outside the casing 34 (as shown in FIG. 4), transmission between the antenna 35 and circuit board 30 must be done through a signal transmission line 37. If the transmission line is too long, signal loss might incur during transmission. However as the antenna 35 is not located inside the casing 34, the casing 34 may be made of metal or non-metal materials.

Based on previous discussions, it is clear that the radio communication apparatus of the invention can maintain the temperature of electronic elements on the surface of the circuit board within a selected range to prevent the radio communication apparatus from malfunction due to too low of temperature. Moreover, when integrating the antenna inside the casing of the radio communication apparatus, installation is easier, and signal loss due to too long of signal transmission line that incurs to conventional techniques can also be avoided. In addition, the invention can employ Ethernet to transmit electric current without additional power cord, installation costs can be further reduced.

While the preferred embodiments of the inventions have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A radio communication apparatus equipped with temperature control function, comprising:
a circuit board including a plurality of electronic elements for processing and converting radio signals;
a metal lid coupled with the circuit board for encasing the electronic elements; and
a heater including a thermo-control switch for sensing temperature of the circuit board to control heating of the metal lid to maintain the temperature of circuit board surface within a selected temperature range.

2. The radio communication apparatus equipped with temperature control function of claim 1, wherein the electronic elements include at least an analog-digital converter, a signal amplifier and a digital signal processor.

3. The radio communication apparatus equipped with temperature control function of claim 1, wherein the heater is a ceramic heater adhering to a surface of the metal lid.

4. The radio communication apparatus equipped with temperature control function of claim 1, wherein the thermo-control switch is a composite metal strip consisting of a bi-metallic strip of two different expansion coefficients.

5. The radio communication apparatus equipped with temperature control function of claim 4, wherein the thermo-control switch is located below the circuit board.

6. The radio communication apparatus equipped with temperature control function of claim 1, wherein the heater maintains the temperature of the circuit board surface in a range between 5 and 20 degrees Celsius.

7. The radio communication apparatus equipped with temperature control function of claim 1, wherein the metal lid is selectively made of aluminum or aluminum alloy.

8. The radio communication apparatus equipped with temperature control function of claim 1, wherein the radio communication apparatus communicates externally by radio signals through an antenna.

9. The radio communication apparatus equipped with temperature control function of claim 8, wherein the radio communication apparatus is separated from the antenna and employs a signal transmission line for transmission, and is housed in a metal casing.

10. The radio communication apparatus equipped with temperature control function of claim 8, wherein the radio communication apparatus and the antenna are integrated inside a casing, the casing proximate to the antenna being made of a non-metal material for preventing shielding effect from incurring to the antenna and affecting signal transmission.
